(19) United States
(12) Patent Application Publication
(10) Pub. No.: US 2018/0332318 A1
(43) Pub. Date: Nov. 15, 2018

(54) SUPPORT OF CROWDSOURCED VIDEO

(71) Applicant: NOKIA SOLUTIONS AND NETWORKS OY, Espoo (FI)

(72) Inventors: Balazs NAGY, San Jose, CA (US); Zoltan SZILADI, San Jose, CA (US)

(21) Appl. No.: 15/775,160

(22) PCT Filed: Sep. 13, 2016
(86) PCT No.: PCT/EP2016/071479

§ 371 Date: May 10, 2018

Related U.S. Application Data
(60) Provisional application No. 62/253,384, filed on Nov. 10, 2015.

(51) Int. Cl. H04N 21/234; H04N 21/2665; H04N 21/274; H04N 21/278; H04N 21/472

(52) U.S. Cl. CPC H04N 21/23418; H04N 21/2665; H04N 21/251; H04N 21/278; H04N 21/47205; H04N 21/274

(57) ABSTRACT

Various networks on which media clips are shared may benefit from appropriate handling of shared media. For example, systems involving video sharing may benefit from methods and devices that support crowdsourced video. A method can include receiving a multimedia element. The method can also include storing the multimedia element as reference content. The method can further include receiving a recording related to the reference content. The method can additionally include storing the recording and a relation between the recording and the reference content. The relationship can include a video-editing relationship to the reference content. The method can also include providing the video-editing relationship upon receiving selection information indicative of at least one of the recording or the reference content.

### CROSS-REFERENCE TO RELATED APPLICATION

This application is related to and claims the benefit and priority of U.S. Provisional Patent Application No. 62/263,384, field Nov. 10, 2015, the entirety of which is hereby incorporated herein by reference.

### BACKGROUND

### Field

Various networks on which media clips are shared may benefit from appropriate handling of shared media. For example, systems involving video sharing may benefit from methods and devices that support crowdsourced video.

### Description of the Related Art

The quality of consumer video recording devices and the speed of mobile broadband have evolved. Consequently, video sharing has become a popular way to communicate among users in the Internet. User generated content (UGC) appears to involve more than 60% of content sharing over the internet.

This type of content can be stored and played separately, even if connected in some way. For example, the same music can be in the background or the videos can be recorded at the same event but from different angles.

Additionally, a situation arises when a video sharing site has multiple copies of a video, including an original version and edited versions. Even though only a portion of the multimedia may require changes, typically the entire content is replicated, edited and stored. This results in wastage of storage. Moreover, a user of the video sharing site may need to search and watch each different version.

### SUMMARY

According to a first embodiment, a method can include receiving a multimedia element. The method can also include storing the multimedia element as reference content. The method can further include receiving a recording related to the reference content. The method can additionally include storing the recording and a relation between the recording and the reference content. The relationship can include a video-editing relationship to the reference content. The method can also include providing the video-editing relationship upon receiving selection information indicative of at least one of the recording or the reference content.

In a variant, the method can further include obtaining a rating for the recording. The method can also include associating the rating with the recording. The method can additionally include recommending the recording based on the rating.

In a variant, the method can also include analyzing the recording to determine metadata of the recording with respect to the reference content. The method can further include associating the determined metadata with the recording and the reference content.

According to a second embodiment, a method can include receiving a selection of a reference content. The method can also include presenting a plurality of recordings related to the reference content, wherein the presenting comprises playing the plurality of recordings in synch with one of the plurality of recordings being displayed as a main recording bigger than the other of the plurality of recordings. The method can further include receiving a selection amongst the other of the plurality of recordings. The method can additionally include promoting the selected recording to be the main recording.

In a variant, the method can further include, when a selected recording ends before the end of the reference content, selecting another of the plurality recording to be the main recording.

In a variant, the method can additionally include receiving an instruction to stop the selected recording. The method can also include receiving a request to edit the reference content. The method can further include editing the reference content based on instructions from a user.

In a variant, the editing can be contingent upon confirmation that the user has privileges to modify the reference content.

According to a third embodiment, a method can include receiving an indication that a user wants to add to a reference content. The method can also include recording, as a record, the user while displaying the reference content. The method can further include playing back to the user the record and the reference content in synch, responsive to a request from the user.

In a variant, the method can additionally include storing the record and an association between the record and the reference content.

In a variant, the method can also include receiving a request to submit the record. The method can further include uploading the record together with an association to the reference content.

According to fourth through sixth embodiments, an apparatus can include means for performing the method according to the first through third embodiments respectively, in any of their variants.

According to seventh through ninth embodiments, an apparatus can include at least one processor and at least one memory and computer program code. The at least one memory and the computer program code can be configured to, with the at least one processor, cause the apparatus at least to perform the method according to the first through third embodiments respectively, in any of their variants.

According to tenth through twelfth embodiments, a computer program product may encode instructions for performing a process including the method according to the first through third embodiments respectively, in any of their variants.

According to thirteenth through fifteenth embodiments, a non-transitory computer readable medium may encode instructions that, when executed in hardware, perform a process including the method according to the first and second embodiments respectively, in any of their variants.

### BRIEF DESCRIPTION OF THE DRAWINGS

For proper understanding of the invention, reference should be made to the accompanying drawings, wherein:

FIG. 1 illustrates a playback user interface, according to certain embodiments.

FIG. 2 illustrates a recording user interface, according to certain embodiments.

FIG. 3 illustrates video ingestion as to individual recording according to certain embodiments.

FIG. 4 illustrates video ingestion as external import according to certain embodiments.

FIG. 5 illustrates a video recommendation process according to certain embodiments.

FIG. 6 illustrates a sample of simple video construction logic, according to certain embodiments.

FIG. 7 illustrates on-screen positioning of videos, according to certain embodiments.

FIG. 8 illustrates a feedback mechanism according to certain embodiments.

FIG. 9 illustrates a method according to certain embodiments.

FIG. 10 illustrates another method according to certain embodiments.

FIG. 11 illustrates a further method according to certain embodiments.

FIG. 12 illustrates a system according to certain embodiments of the invention.

### DETAILED DESCRIPTION

Certain embodiment may provide a way to help select the best videos for a given time and cut them in proper order. Thus, certain embodiments may assist in the combination of user generated content to provide a better experience for a consumer of such content.

Certain embodiments permit collaborative content editing, which may help to improve the lifetime of the video content. This editing may also improve user experience and content storage.

Certain embodiments may also avoid unnecessary replication of the same content in different versions on a server. Instead, certain embodiments may improve content for each user. Thus, one copy may be stored, but improvements can be made while avoiding duplicates or replications of the entire content.

Additionally, certain embodiments may allow collaborative content filtering. Thus, multiple users may be able to improve the content based on their policies without violating any of the original content owners' rights in the content.

Also, certain embodiments may enhance user experience and satisfaction by allowing ensembles of recommendation algorithms.

Furthermore, certain embodiments may minimize and/or avoid same content replication with an intelligent process of content editing. Thus, so the improved multi-media portions can be combined and delivered in real-time.

Additionally, certain embodiments may assist a user in uploading content to a given video in order improve it. Certain embodiments may avoid the obstacle of a lack of policy validation between the original content owner and the user who would like to modify the content.

Moreover, certain embodiments may address the situation in which a user is unable to impact a video by implicit or explicit feedback. Certain embodiments may also assist in personalization, such that a registered user may be able to get personalized video and/or personalized content based on the user's profile.

Certain embodiments can address the situation in which users are unable to upload videos from devices where synchronization information is missing.

More generally, certain embodiments can combine video editing, user profile management, and content storage in compact form to represent both original and modified content. Certain embodiments can be applied both to premium content, and to user generated content

Certain embodiments may also provide a way to perform crowdsourcing of video content. Also, certain embodiments may allow policy based user viewing, while avoiding multiple search on the same content.

A user, in the context of certain embodiments, can be a person who visits a user interface and interacts with the user interface. The interactions can include, for example, watching videos, giving feedback or records and submitting the user's own video. The user can be registered or anonymous. In certain embodiments, for a particular current session, the user may always possess a unique identification, which can be referred to as a user_id.

In certain embodiments, reference content can serve to initiate and give a timeline for users to upload videos. The reference content can be audio or/and visual content. Multiple reference contents can be present in the system. Thus, an identifier can be associated with the reference. This identifier can be referred to as ref_id.

In certain embodiments, a recording can be used to modify reference content. For example, a user can record a recording and submit the recording to the platform to modify a particular reference content. This recording can be assigned an identification, which can be referred to as rec_id.

Metadata can, in certain embodiments, be stored along with the recording. This metadata may identify the reference content, as well as start and end time of the recording relatively to the reference content. Other metadata can also be used.

Certain embodiments can include various components. For example, certain embodiments can include a user interface (UI) where a user can watch the current state of a video, record and submit a new video, and/or give feedback. The user interface can also serve the purpose of adding new reference content to the system.

Certain embodiments can include various storage systems. For example, certain embodiments can also include a video store. The video store can store reference content and recordings. Certain embodiments can further include one or more database that stores the metadata and feedback from users.

Certain embodiments can also include a recommender system. The recommender system can make recommendations and can determine the ratings of recordings for a current user.

Certain embodiments can further include video editor logic. The video editor logic can put the recordings together and can recommend alternative recordings based on the metadata of the recordings and the ratings that the recommender system predicted.

Certain embodiments can additionally include an analyzer that analyses the recordings in order to determine the metadata of the recording. This analysis may be performed, for example, if the metadata is not complete at the time of submission of the recordings.

The following is an example of how playback may proceed in certain embodiments, from a user point of view. Initially, the user may open the user interface (UI) and select a reference content. The UI may be an application or app, a browser page or plugin, or any other mechanism for providing a user interface.

The user may start playing the reference content. The user may, for example, select a “play” button from a menu of available buttons, such as play, pause, reverse, and forward. Alternatively, the reference content may immediately begin playing upon selection of the reference content by the user. Other mechanisms for playing the reference content are also permitted.

The UI can also offer alternative recordings, which can be played in sync to the reference content. Alternative videos can be differentiated in their size. The main video, which is bigger, can be a video predicted by the system to be liked by the user. The alternative videos can be presented smaller.

The user can choose from alternative recordings. For example, the user may decide that the user prefers another video more than the main video. When an alternative recording is selected, it can replace the main video.

Once a chosen alternative recording ends, the UI can continue recommending based on the remaining timeline of the reference content. The UI can also optionally automatically promote a recommended alternative recording to be the main video.

In certain embodiments, the user can stop the content at any time and can start editing it. There can be various safeguards in place with respect to editing. For example, the content can be modified by the content owner or by other users who could have privileges to modify the content. Policy configuration required to view, modify, redistribute can be validated before each operation on the content. Moreover, content that are modified by the same or the different users who have privileges can again be validated by policy that resides as part of the video editing sub-system or as a separate entity.

A revocation process can be integrated into the video editing procedure. This process can include content validation while modifying the existing content or adding changes to the existing content. Options can be presented to get permission after alteration.

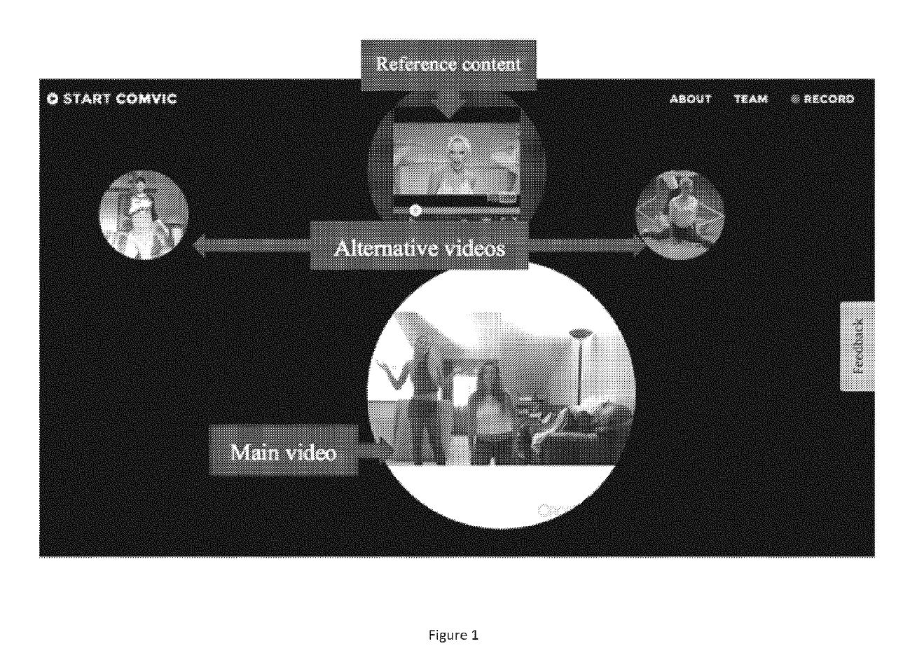

FIG. 1 illustrates a playback user interface, according to certain embodiments. FIG. 1 is just one example of how a user interface could be presented. As shown in FIG. 1, a main video can be displayed in a large size near the center of the screen. The reference content may be displayed in a medium size near the top center of the screen. Alternative videos may be displayed in smaller sizes, for example to the sides.

The reference content may include a bar that indicates time progress relative to the overall length of the reference content.

As shown in FIG. 1, there may also be other selectable items, including a play button in the top left corner, a feedback tab on the right hand side, as well as “about” and “team” tabs to display information about the product or team. Additionally, there can be a “record” tab that can permit a user to contribute additional content to be associated with the reference content.

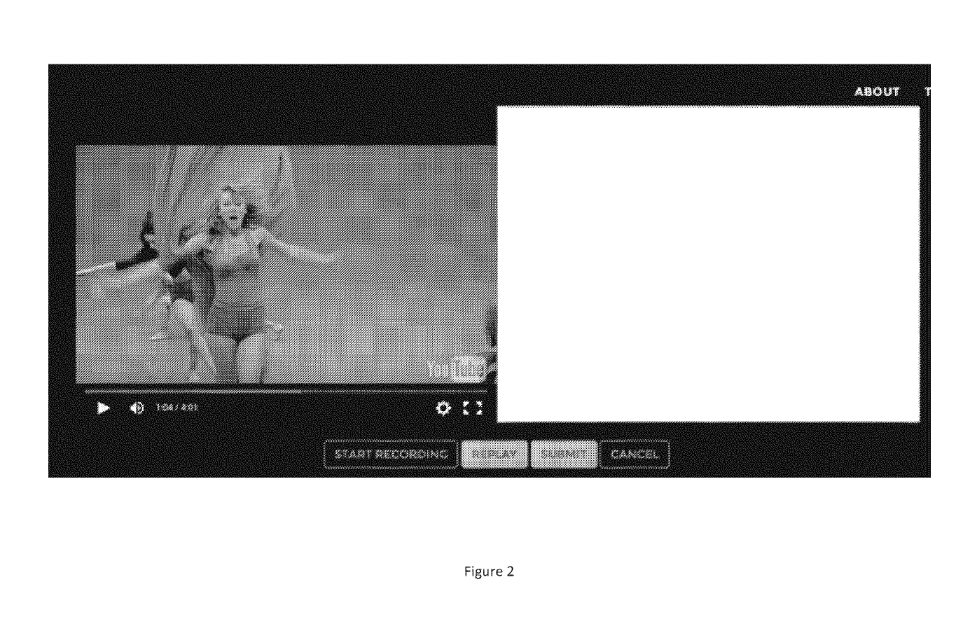

FIG. 2 illustrates a recording user interface, according to certain embodiments. As shown in FIG. 2, there can be room in the recording user interface to show reference content, for example on the left, and currently recorded content, for example, on the right.

A user may get to this recording user interface by selecting an option (for example, in another view) that indicates the user wishes to add new content. The user interface can then change to another page, for example the page shown in FIG. 2, where the user can “Start Recording” while the reference content is played.

The user can also stop the recording and subsequently replay the user's recording in a synchronized way with respect to the reference content. The “replay” button shown can be used for this purpose.

If the user enjoys the content, the user can select the submit button to add the content to the system. Alternatively, the user can “Cancel” the recording.

Certain embodiments may employ a variety of technical implementations for providing the above-described and other features. For example, certain embodiments may provide techniques and systems for video ingestion, video recommendation, synchronized playback, and feedback.

Video ingestion can include several aspects. Video ingestion can include operations of adding new recordings to the system, indexing the new recordings, and creating metadata in order to enable playback. Video ingestion can be done in several ways, of which the following are examples.

Content, including recordings and reference content, can be obtained in several ways. For example, there can be individual recording and external import.

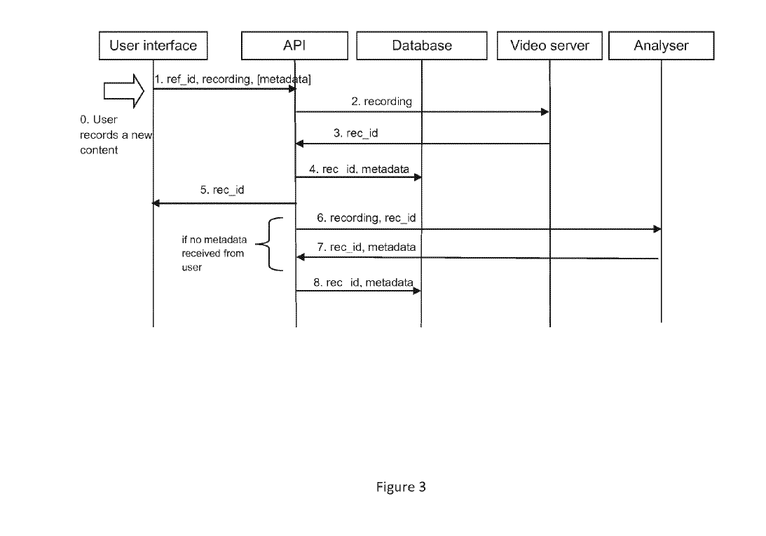

FIG. 3 illustrates video ingestion as to individual recording according to certain embodiments. This recording can occur when a user wants to add new content to the reference content. Thus, the user may upload the user's content for a given period of time of a timeline of the reference content.

As shown in FIG. 3, at 9 a user can navigate. This navigation can involve a user pressing a “Start recording” button on the recording page. The UI can take a current timestamp of reference content that is being played along with the recording. This timestamp can be referred to as the start time of the recording. When the user presses “Stop recording,” the UI can take the current timestamp of the reference content, which can be referred to as the end time. These two timestamp can be used for instant playback in such a way that when the user presses “Replay”, the system rewinds the reference video to the start time and plays from that time.

At 1, when the user presses “Submit”, the UI can extract the recording from the recording's container and can send the recording to the application programming interface (API) along with ref_id, start time, and end time as metadata. There may be different implementations of the UI on different devices, such as a smartphone. For example, the reference content may not be played on the device, but in the background. In this case the UI may not be able to send the whole metadata and the server may need to ascertain the metadata, as provided for at 6 and 7, described below.

At 2, the API can send a recording to a video server in order to save the recording. The video server can be combined with the database or can be provided as a separate content delivery network (CDN) server.

At 3, the video server can store the video and generates an identifier, which can uniquely identify the recording. As mentioned above, this can be referred to as rec_id.

At 4, the API can save the rec_id along with the metadata in the database, if metadata is present. Then, at 5, the API can send back the rec_id to the user interface in the acknowledgement.

At 6, if the metadata was not present in message #1, the API can send the recording to an analyzer to retrieve the metadata. At 7, the analyzer can extract, for example, the audio track from the recording and can compare the audio track of the recording to the audio track of a reference video in order to find a time when the recording was taken during the reference content. Additional discussion of this technique is discussed below. The analyzer can send back the metadata and rec_id.

At 8, the API can store the metadata to a corresponding recording by sending rec_id and metadata to the database.

Another alternative way of acquiring content is external import. External import can be used when a new reference content is created. For example, an administrator may want to fill the system with videos from external sources. This process can involve finding related videos to the reference content and analyzing, indexing and storing the metadata in the database.

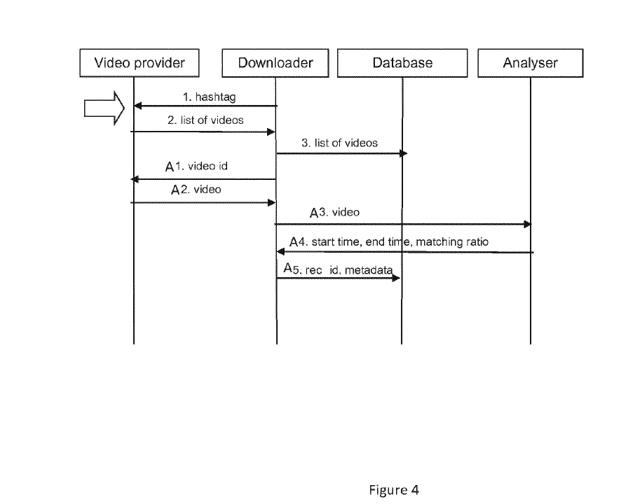

FIG. 4 illustrates video ingestion as external import according to certain embodiments. As shown in FIG. 4, at 1 a downloader can be started by the system administrator to initiate the external import with the following parameters: a hashtag, which identifies videos on the external video provider; and reference content id, identifies the video.

The downloader can use the video provider's API to list all the videos in the video provider's database related to the given hashtag. In case of vine.co the mechanism can be to use https://vine.co/api/posts/search/[hashtag].

At 2, the video provider can provide the metadata of the videos. Then, at 3, the downloader can save all the metadata in the database and can repeat the following steps for each of the videos.

At A1, the downloader can start to download the videos one-by-one. At A2, the video provider can send the video. Then, at A3, the downloader can forward the video to an analyzer. At A4, the analyzer can extract information, such as the audio track, from the video and can match the extracted information with reference content. The analyzer can return the start time, end time and matching ratio to the downloader.

The extraction of information can involve a variety of procedures. For example, the analyzer can take the Fourier transformation of the audio track and create frequency bands. In each of the frequency bands the analyzer can locate the time of local maximum. The analyzer can repeat these transformation and local maximum location steps for both the reference content and video under import. The analyzer can then find the time period when the number of matching maximum from the reference and the imported video is the highest.

At A5, the downloader can save start time, end time, matching ratio in the database and delete the video.

Once downloader has finished downloading all the videos, the system administrator can move the videos based on the matching ratio to the live video collection. That collection can store the necessary information for synchronized playback. An example of a possible video object could be the following:

{ “_id” : ObjectId( “55fc7d13fa021e379286e01d” ),
“videoUrl”:
“http://mtc.cdn.vine.co/r/videos/D04CB14359111469
5226687418368_2ee27ec197d.5.1.3922389212699
738811.mp4?versionId=6eeAfZSC_BuGlkew8oRbo
SfJhkiJBFAK”,“vine” :“username” : “Don Jose”,
“permalinkUrl” : “https://vine.co/v/MLXV7AgLgpv”,
“description” : “In life your will always have people
who #hate like Taylor Swift says #shakeitoff” },
“youtubeId” : “nfWlot6h_JM”, “startTime” :
23.82367346938776, “endTime” :
29.97696145124717 }

Another aspect of the system design can include video recommendation. Video recommendation can include a set of operations by which the system constructs the screenplay that will be used by the UI to play back the reference content along with the main and alternative videos in a synchronized way. This operation can be based on users' feedback and the metadata stored in the database.

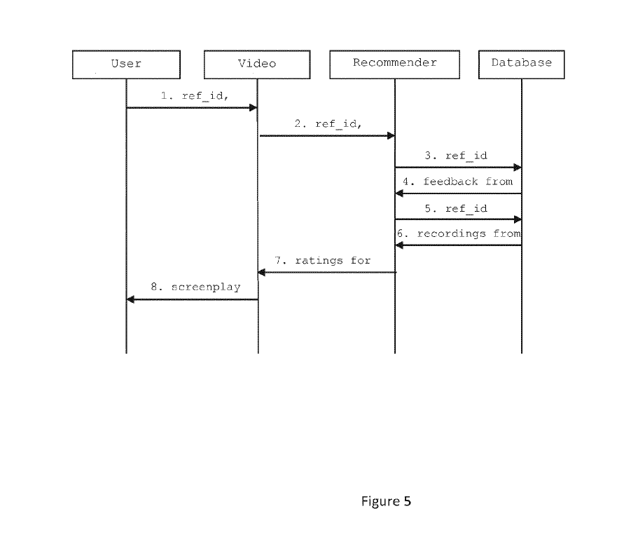

FIG. 5 illustrates a video recommendation process according to certain embodiments. At 1, the UI can send the ref_id and user_id to the video editor. A possible API request may be in the form of a hyper-text transfer protocol (HTTP) GET request:

/plot/recommend?youtubeId=nfWlot6h_JM&sessionI
d=13dk5tlb7c9h81k6bg14 .

At 2, the video editor may simply forward these IDs to the recommender, without further action at this stage. Then, at 3, the recommender can request all the feedback for the given reference content, including the current user. The feedback can be cached, except perhaps for feedback for the current user, as the UI may have direct access to the feedback for the current user.

At 4, the database can send all the feedback requested. Then, at 5, the recommender can request the metadata of all the recordings submitted to the given reference. The metadata can be cached. For purpose of illustration, this discussion omits policy related functions on the content and user. Nevertheless, such policy related functions can be applied.

At 6, the database can send the requested metadata. Then, at 7, the recommender can calculate a score for each recording. One possible implementation could be the following. First, the recommender can take all the recordings to the given reference content and assign a default score of 1500 to each of them. Then, after this normalization step, the recommender can take all the feedback events that are related to video switches initiated by the user. After that, the recommender can use an Elo rating system to update the scores based on each feedback. For the purposes of applying an Elo rating, if there was a switch by a user from one video to another, then it can be considered that the first video lost the game and the second video won. A person of ordinary skill in the art of Elo ratings and other ranking systems can apply further aspects of Elo ratings and other ranking systems along the lines discussed above. Accordingly, further detail of this ranking/rating is not set forth explicitly here. For more discussion of such systems, see “Who's #1?: The Science of Rating and Ranking,” of Langville et al. (Princeton University Press: 2012), which is hereby incorporated herein by reference in its entirety.

In this way, or any other desired way, a ranked list can be established among all the recordings. This list can be sent back to the video editor as pairs of ref_id and score. A different mechanism could be applied to give different scores to different users based on their profile.

The video editor's task can include determining which recordings should be displayed, as well as what time and which one should be selected as a main video. One possible way of doing this is to maintain a list of ordered blocks, which describes the timeline and contains the information about start time, end time, main video and alternative videos. The video editor can also order the scored list of recordings by the score in a descending order. The video editor can iteratively take the next recording and do the following as long as the end of the list is not reached. First, the video editor can find the impacted blocks based on the start time and end time. Second, the video editor can figure out if the block can be placed for that given time with a constraint on a number of parallel videos, time left on the screen, and time left as main video. These restrictions may be used in order to provide better user experience. Third, the video editor can, if the recording can fit into its time period, split the starting and ending block in order to precisely follow the timeline of the recording. The video editor can go through all the impacted blocks and place the recording either as a main video or an additional alternative video.

Then, the video editor can shuffle the order of the recordings randomly in order to give a chance to other videos. After that, the video editor can repeat the iterative step while increasing an allowed number of parallel videos in order to place a few random videos on the screen. This may allow the new videos to be displayed even if the order is stable.

Finally, at 8, the video editor can return the screenplay. The video editor may use the following format: an array of blocks, the start and end time of each block, an identification of a main video, and a list of alternative videos.

The following is an example of how that format may be presented:

[

{

“startTime”: 0,
“endTime”: 0.25541950113378686,
“main”: null,
“sub”: [ ]

},
{

“startTime”: 0.25541950113378686,
“endTime”: 0.301859410430839,
“main”: null,
“sub”: [

“55fc7d14fa021e379286e266”

]

},
{

“startTime”: 0.301859410430839,
“endTime”: 1.172631,
“main”: null,
“sub”: [

“55fc7d14fa021e379286e266”,
“55fc7d14fa021e379286e1ef”

]
},
{

“startTime”: 1.172631,
“endTime”: 4.922630385487528,
“main”: “558d84866f1aa97804694dbf”,
“sub”: [

“55fc7d14fa021e379286e266”,
“55fc7d14fa021e379286e1ef”

]

}, ...]

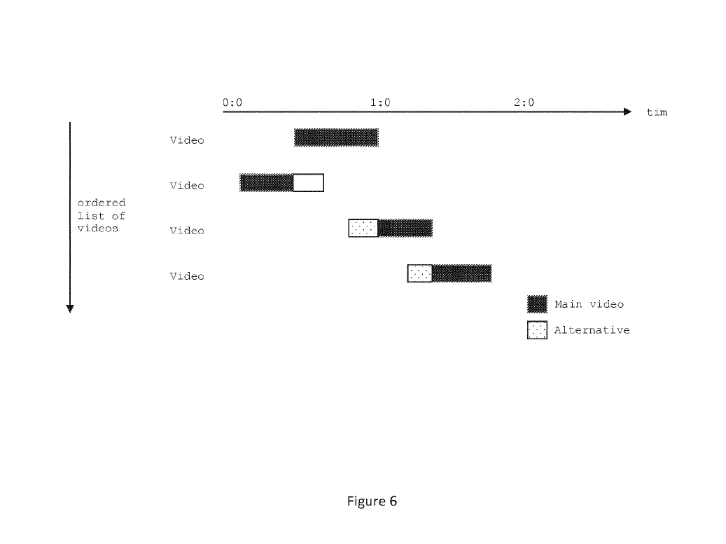

Synchronized playback of the videos can be accomplished in a variety of ways, of which the following is an example. For example, FIG. 6 illustrates a sample of simple video construction logic, according to certain embodiments.

As shown in FIG. 6, different videos can be selected as the main video at different times. Thus, the videos can form a compilation that automatically switches from the second video to the first, to the third and finally to the fourth, in this particular example. Nevertheless, the user may optionally select to make the alternative video for a given time period the primary video.

When a user opens the user interface, the UI can turn to the API to download the screenplay for a given reference content. Screenplay can include several blocks ordered by time, as shown in FIG. 6. When the user starts playing the reference content, the user interface can go through the list to render the videos in the following way.

First, the UI can retrieve the current timestamp of the reference content. Then, the UI can find the block whose start time is less than the current timestamp and the end time is greater. After that, the UI can update the visibility of the videos according to the current block.

For example, the UI can hide the videos that are not present in the block. The UI can add the videos that are in the block but not visible yet. An example of the logic to find the position of the new videos is discussed below. Finally, the UI can make the main video bigger and the old main video normal.

Once the UI has updated the video, the UI can set a timer for end time of the block. Then, the UI can restart the same process, when the timer expires or otherwise indicates the end of the block has arrived or is approaching.

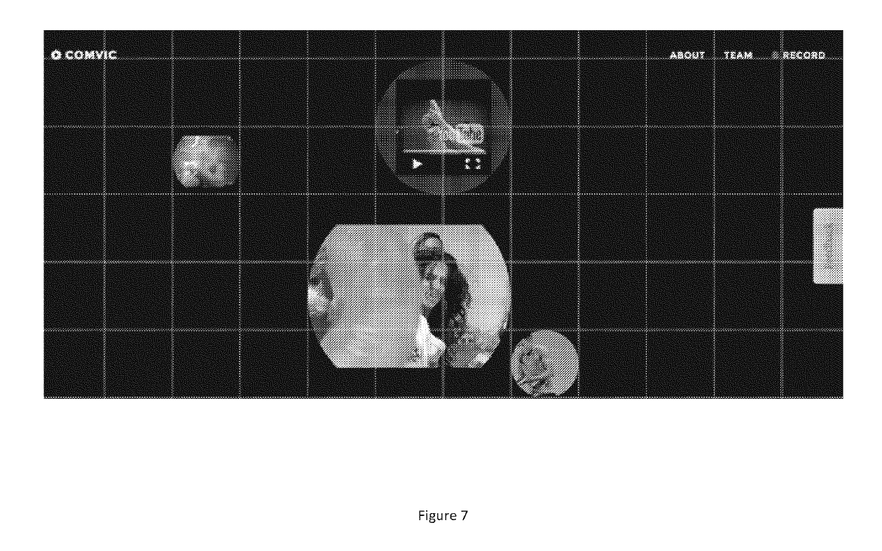

FIG. 7 illustrates on-screen positioning of videos, according to certain embodiments. There can be various ways of determining the position of the videos on the screen. Because the alternative videos may grow in size when they are selected to be the main video, they can be placed in a way that allows for them to be displayed without overlapping each other.

For example, the alternative videos can be placed pseudo-randomly on the screen. This placement may yield an enjoyable user experience. A slot allocation algorithm may be responsible for placing the alternative videos on the screen while ensuring that they will not overlap. The following is one example of a possible mechanism for slot allocation.

Instead of using any pixel position on the screen, a simplified model may use a grid for the placement of the videos, as shown in FIG. 7. The reference content, main video and alternative videos can be sized in a way that their height and width is a multiple of the grid square size. This may simplify the allocation.

The system can keep track of the status of the grid. Positions can be considered occupied if a video is displayed in the specific position, or if a nearby video can grow onto that position. Otherwise, empty squares can be considered unoccupied.

When a next alternative video is to be placed on the screen, the system can pick a random grid position. The system can then check whether the square has enough surrounding unoccupied positions for the video to grow into the main video upon selection.

The calculation of the possibility for growing in size can be done by checking the main video size positions from the alternative video's position in all possible directions: in-place, and in 8 directions: two horizontal, two vertical, and four diagonal.

If the video can grow in any of these directions, then that direction can be selected for future growth of the video and the positions it would occupy after growing can be marked as occupied in the grid. This marking or reservation can ensure that if an alternative video needs to grow, then it will not grow on top of another video.

If the random position and growth direction selection was successful, then the video can be placed in the designated position and can be displayed on the screen. If the random position or the growth direction was not successful, either because the random position is occupied or the video could not grow from that position, then the next position can be tested until a suitable position is found.

The system can take into account the borders of the screen and also the main video. These boundaries may prevent growth in the direction of the boundary. The boundaries can be placed at the edge of the screen for the UI, or can be placed within a frame or window within the UI. For example, the UI may occupy the whole display device, most of the display device, but with a frame around the UI, or a window of the display device.

Once the alternative or main video finishes playback and disappears from the screen, the system can mark the spots previously occupied by the video as unoccupied positions of the grid, in order to ensure that they are considered for future video position allocations. Thus, the number of videos simultaneously displayed may increase or decrease, or both, over the course of playing over a reference timeline.

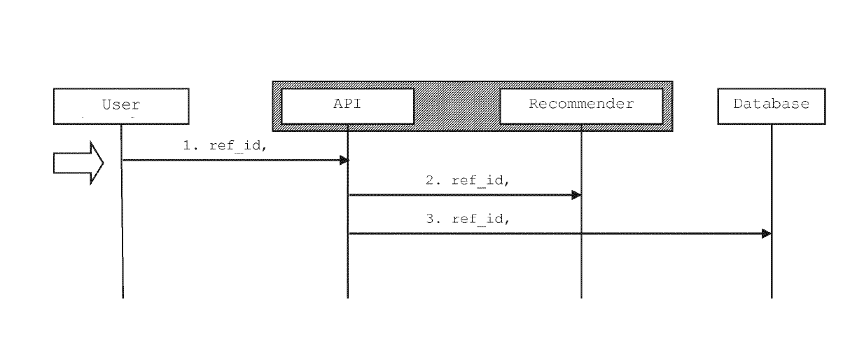

FIG. 8 illustrates a feedback mechanism according to certain embodiments. A feedback engine may be used to capture data for a recommendation section of the system. The UI can record all the changes during the playback, so the full screenplay can be reconstructed. The location of the videos can be excluded from consideration if they are to be pseudo-randomly located, as described above. Thus, the system can know what the user actually has seen on the UI, and the user's decision can be precisely analyzed.

As shown in FIG. 8, at 0 the UE can subscribe for different events in order to collect them. In order to avoid performance issues or for other reasons, the UI can collect the events for a certain time before the UE sends them to the API. The system can record a variety of information including, for example, the following events.

A first event can be that the user switches to or selects an alternative video. The UI can detect this change by listening for a hovering event on the video element. A second event can be that any video is added to or removed from the screen. The UI can detect this information from its own logic.

At 1, the UI can report to the API by sending the current ref_id, user_id and a description of the event. One possible implementation is to send an HTTP POST to /action/bulk URL with the following content:
actions[0][action]:plotChanged
actions[0][params][userSelected]:false
actions[0][currentTime]:0
actions[0][sessionId]:1Immnjr1s5fdpn1r03d7d
actions[0][youtubeId]:nfWlot6h_JM
actions[1][action]:plotChanged
actions[1][params][userSelected]:false
actions[1][context][main]:
actions[1][currentTime]:0.406401
actions[1][session]:1Immnjr1s5fdpn1r03d7d
actions[1][youtubeId]:nfWlot6h_JM

At 2, the API can broadcast the events to the recommender. Thus, the recommender can update the recommender status according to the method described above, or any other desired method.

At 3, the API can send the feedback to a database. Then the database can save the feedback permanently or on a revolving basis.

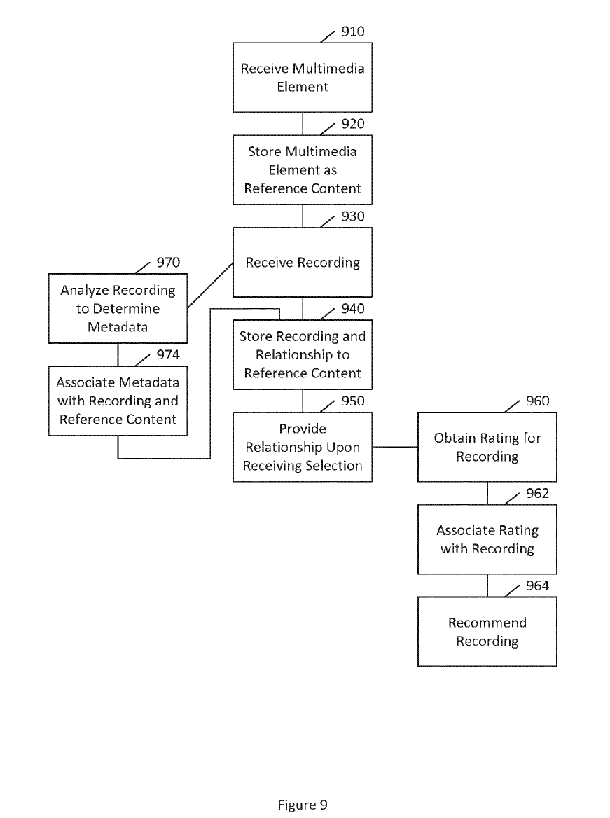

FIG. 9 illustrates a method according to certain embodiments. The method can include, at 910, receiving a multimedia element. This multimedia element may be video recording or any similar element, including a three-dimensional video recording, a video recording including multiple angles, or the like. A video clip is a non-limiting example of a multimedia element.

The method can also include, at 920, storing the multimedia element as reference content. In certain embodiments, every stored multimedia element may initially be treated as reference content until its relationship to other content is known or decided. In certain embodiments, the reference content may be stored externally, and a system implementing the method may store a pointer or reference to the reference content.

The method can further include, at 930, receiving a recording related to the reference content. This recording may be, for example, a user reaction to the reference content, another video angle corresponding to the reference content, or a video edit the reference content. The video edit may be a dubbing, sub-titling, audio replacement, or the like. The video edit may also include other changes or additions, such as censoring, adding audio or visual layer(s), changing an aspect ratio, stabilizing video, or the like. The video edit can also include purely audio edits, like changing the pitch of an audio track, converting a mono track into a simulated stereo track, or the like.

The method can also include, at 940, storing the recording and a relation between the recording and the reference content. The relationship can include a video-editing relationship to the reference content. In this context a video-editing relationship can include information such as relative start time and/or end time with respect to the reference content. Additional data can also be provided that can establish more information about the relationship between the recording and the reference content. As can be seen from above, this video-editing relationship does not necessarily require that the recording be an edition of the reference content. For example, the recording may be a separately recorded angle of an event recorded in the reference content. As with the reference content, in certain embodiments the recording may be stored externally. Thus, a system implementing the method may store a pointer or reference to the recording.

The method can further include, at 950, providing the video-editing relationship upon receiving selection information indicative of at least one of the recording or the reference content. This may involve providing the relationship to a user interface so that the user interface can display the video at an appropriate place and/or time in a presentation.

The method can also include, at 960, obtaining a rating for the recording. As mentioned above, this rating can be based on user behavior with respect to the recording, such as switching to or from the recording. The rating can be piecewise with respect to the recording, for example in 30 second segments, or can be for the entire recording. The method can further include, at 962, associating the rating with the recording. The method can additionally include, at 964, recommending the recording based on the rating. This recommending can include recommending the recording to be presented as a main recording for one or more period of time in a multi-video synchronized presentation.

The method can also include, at 970, analyzing the recording to determine metadata of the recording with respect to the reference content. This metadata may be, for example, the video editing relationship. The method can further include, at 974, associating the determined metadata with the recording and the reference content.

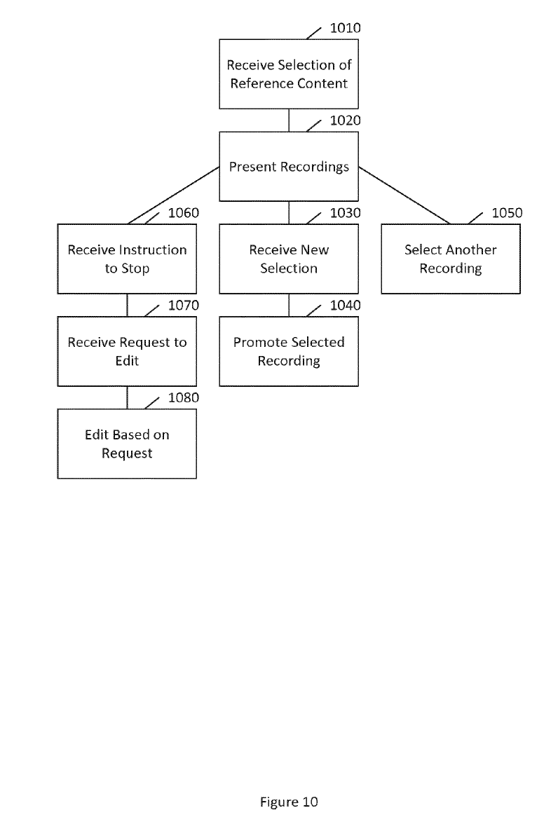

FIG. 10 illustrates another method according to certain embodiments. As shown in FIG. 10, a method can include, at 1010, receiving a selection of a reference content. The method can also include, at 1020, presenting a plurality of recordings related to the reference content. The presenting can include playing the plurality of recordings in synch with one of the plurality of recordings being displayed as a main recording bigger than the other of the plurality of recordings. The decision as to which recording to treat as being the main one can be based on a recommendation, for example, as generated in a method as shown in FIG. 9. The recordings can be synchronized with respect to a reference timeline, which can be based on the reference content.

The method of FIG. 10 can also include, at 1030, receiving a selection amongst the other of the plurality of recordings. The method can further include, at 1040, promoting the selected recording to be the main recording. For example, a system implementing the method may detect a user click, press, or hover over one of the alternative recording and may consequently decide to make that the main recording and the previous main recording can then become one of the alternative recordings.

The method can also include, at 1050, when a selected recording ends before the end of the reference content, selecting another of the plurality recording to be the main recording. An example of this can be seen in FIG. 6, where several times before the expiry of the overall time there are several switches to alternative videos at the end of a main video.

The method can also include, at 1060, receiving an instruction to stop the selected recording. The method can further include, at 1070, receiving a request to edit the reference content. The method can additionally include, at 1080, editing the reference content based on instructions from a user. The editing can be contingent upon confirmation that the user has privileges to modify the reference content. Thus, some system of authentication or the like can be applied to provide such confirmation of user privileges.

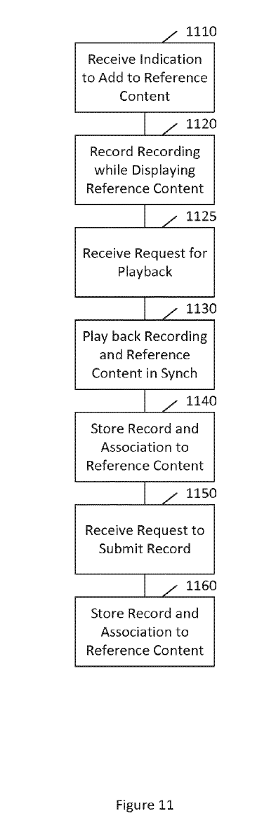

FIG. 11 illustrates a further method according to certain embodiments. As shown in FIG. 11, a method can include, at 1110, receiving an indication that a user wants to add to a reference content. The method can also include, at 1120, recording, as a record, the user while displaying the reference content. The recording can be a self-video of the user or any video or audio recording by equipment controlled by the user. The method can further include, at 1130, playing back to the user the record and the reference content in synch, responsive to a request, at 1125, from the user.

The method can also include, at 1140, storing the record and an association between the record and the reference content. The method can also include, at 1150, receiving a request to submit the record. This may be a request from a user. The method can further include, at 1160, uploading the record together with an association to the reference content.

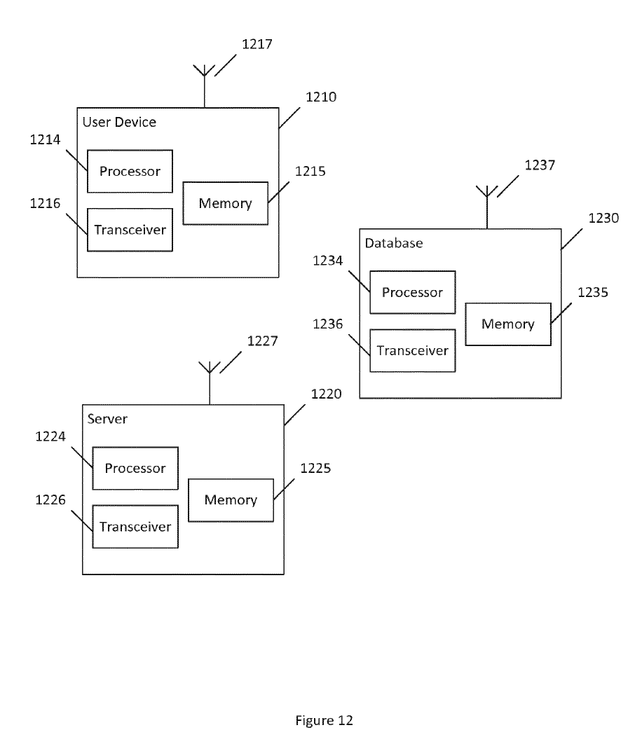

FIG. 12 illustrates a system according to certain embodiments of the invention. In one embodiment, a system may include multiple devices, such as, for example, at least one user device 1210, at least one server 1220, and at least one database 1230. The user device 1210 may be any terminal equipment, such as a personal computer, a tablet computer, a smart phone, a personal digital assistant, a mobile computing device, or any device equipped with a web browser. The server 1220 may be configured as a video server or analyzer as shown in FIG. 3, a video provider, downloader, or analyzer as shown in FIG. 4, a video provider or recommender as shown in FIG. 5, or a recommender as shown in FIG. 8. The user device 1210 and/or the server 1220 may be configured to provide or work with an API as described herein.

Each of these devices may include at least one processor, respectively indicated as 1214, 1224, and 1234. At least one memory can be provided in each device, and indicated as 1215, 1225, and 1235, respectively. The memory may include computer program instructions or computer code contained therein. The processors 1214, 1224, and 1234 and memories 1215, 1225, and 1235, or a subset thereof, can be configured to provide means corresponding to the various blocks of FIGS. 9 through 11.

As shown in FIG. 12, transceivers 1216, 1226, and 1236 can be provided, and each device may also include an antenna, respectively illustrated as 1217, 1227, and 1237. Other configurations of these devices, for example, may be provided. For example, database 1230 may be configured for wired communication, instead of wireless communication, and in such a case antenna 1237 can illustrate any form of communication hardware, without requiring a conventional antenna.

Transceivers 1216, 1226, and 1236 can each, independently, be a transmitter, a receiver, or both a transmitter and a receiver, or a unit or device that is configured both for transmission and reception.

Processors 1214, 1224, and 1234 can be embodied by any computational or data processing device, such as a central processing unit (CPU), application specific integrated circuit (ASIC), or comparable device. The processors can be implemented as a single controller, or a plurality of controllers or processors.

Memories 1215, 1225, and 1235 can independently be any suitable storage device, such as a non-transitory computer-readable medium. A hard disk drive (HDD), random access memory (RAM), flash memory, or other suitable memory can be used. The memories can be combined on a single integrated circuit as the processor, or may be separate from the one or more processors. Furthermore, the computer program instructions stored in the memory and which may be processed by the processors can be any suitable form of computer program code, for example, a compiled or interpreted computer program written in any suitable programming language.

The memory and the computer program instructions can be configured, with the processor for the particular device, to cause a hardware apparatus such as user device 1210, server 1220, and database 1230, to perform any of the processes described herein (see, for example, FIGS. 9 through 11). Therefore, in certain embodiments, a non-transitory computer-readable medium can be encoded with computer instructions that, when executed in hardware, perform a process such as one of the processes described herein. Alternatively, certain embodiments of the invention can be performed entirely in hardware.

Furthermore, although FIG. 12 illustrates a system including a user device, server, and database, embodiments of the invention may be applicable to other configurations, and configurations involving additional elements. For example, not shown, additional user devices may be present, and additional network elements may be present, as illustrated in FIGS. 3, 4, 5, and 8.

Certain embodiments may have various benefits and/or advantages. For example, certain embodiments may permit collaborative content editing and make the results of such editing available to users. Certain embodiments may play out a video based on user policy and profiles and may avoid unnecessary search by users. Furthermore, certain embodiments may increase the lifetime of each video and improve user satisfaction of content when delivered over the Internet.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

### List of Abbreviations

API: Application Program Interface. Interface between the frontend and backend systems.

ID: Identifier

UI User Interface

1.-32. (canceled)

33. A method, comprising:
receiving a multimedia element;
storing the multimedia element as reference content;
receiving a recording related to the reference content;
storing the recording and a relation between the recording and the reference content, wherein the relationship comprises a video-editing relationship to the reference content; and
providing the video-editing relationship upon receiving selection information indicative of at least one of the recording or the reference content.

34. The method of claim 33, further comprising:
obtaining a rating for the recording;
associating the rating with the recording; and
recommending the recording based on the rating.

35. The method of claim 33, further comprising:
analyzing the recording to determine metadata of the recording with respect to the reference content; and
associating the determined metadata with the recording and the reference content.

36. The method of claim 33, further comprising:
presenting a plurality of recordings related to the reference content, wherein the presenting comprises playing the plurality of recordings in synch with one of the plurality of recordings being displayed as a main recording bigger than the other of the plurality of recordings;
receiving a selection amongst the other of the plurality of recordings; and
promoting the selected recording to be the main recording.

37. The method of claim 36, further comprising:
when a selected recording ends before the end of the reference content, selecting another of the plurality recording to be the main recording.

38. The method of claim 36, further comprising:
receiving an instruction to stop the selected recording;
receiving a request to edit the reference content; and
editing the reference content based on instructions from a user.

39. The method of claim 38, wherein the editing is contingent upon confirmation that the user has privileges to modify the reference content.

40. An apparatus, comprising:
at least one processor; and
at least one memory including computer program code,
wherein the at least one memory and the computer program code are configured to, with the at least one processor, cause the apparatus at least to
receive a multimedia element;
store the multimedia element as reference content;
receive a recording related to the reference content;
store the recording and a relation between the recording and the reference content, wherein the relationship comprises a video-editing relationship to the reference content; and
provide the video-editing relationship upon receiving selection information indicative of at least one of the recording or the reference content.

41. The apparatus of claim 40, wherein the at least one memory and the computer program code are further configured to, with the at least one processor, cause the apparatus at least to
obtain a rating for the recording;
associate the rating with the recording; and
recommend the recording based on the rating.

42. The apparatus of claim 40, wherein the at least one memory and the computer program code are further configured to, with the at least one processor, cause the apparatus at least to
analyze the recording to determine metadata of the recording with respect to the reference content; and
associate the determined metadata with the recording and the reference content.

43. The apparatus of claim 40, wherein the at least one memory and the computer program code are further configured to, with the at least one processor, cause the apparatus at least to:
present a plurality of recordings related to the reference content, wherein the presenting comprises playing the plurality of recordings in synch with one of the plurality of recordings being displayed as a main recording bigger than the other of the plurality of recordings;
receive a selection amongst the other of the plurality of recordings; and
promote the selected recording to be the main recording.

44. The apparatus of claim 43, wherein the at least one memory and the computer program code are further configured to, with the at least one processor, cause the apparatus at least to, when a selected recording ends before the end of the reference content, select another of the plurality recording to be the main recording.

45. The apparatus of claim 43, wherein the at least one memory and the computer program code are further configured to, with the at least one processor, cause the apparatus at least to
receive an instruction to stop the selected recording;
receive a request to edit the reference content; and
edit the reference content based on instructions from a user.

46. The apparatus of claim 45, wherein the editing is contingent upon confirmation that the user has privileges to modify the reference content.

47. An apparatus, comprising:
at least one processor; and
at least one memory including computer program code,
wherein the at least one memory and the computer program code are configured to, with the at least one processor, cause the apparatus at least to
receive an indication that a user wants to add to a reference content;
record, as a record, the user while displaying the reference content; and
play back to the user the record and the reference content in synch, responsive to a request from the user.

48. The apparatus of claim 47, wherein the at least one memory and the computer program code are further configured to, with the at least one processor, cause the apparatus at least to store the record and an association between the record and the reference content.

49. The apparatus of claim 47, wherein the at least one memory and the computer program code are further configured to, with the at least one processor, cause the apparatus at least to
receive a request to submit the record; and
upload the record together with an association to the reference content.

50. A computer program product embodied on a non-transitory computer-readable medium encoding instructions for performing a process when executed in hardware, the process comprising the method according to claim 33.
